(19) United States
(12) Patent Application Publication
(10) Pub. No.: US 2016/0204937 A1
(43) Pub. Date: Jul. 14, 2016

(54) SYSTEM AND METHOD FOR STORING AND TRANSMITTING CONFIDENTIAL MEDICAL INFORMATION ON VULNERABLE DEVICES AND NETWORKS

(71) Applicant: REFLEXION HEALTH, INC., San Diego, CA (US)

(72) Inventors: SAM EDWARDS, SAN DIEGO, CA (US); ALEX MAULT, Lakewood, CO (US); KEVIN STENERSON, San Diego, CA (US)

(21) Appl. No.: 14/993,650

(22) Filed: Jan. 12, 2016

Related U.S. Application Data
(60) Provisional application No. 62/102,858, filed on Jan. 13, 2015.

(51) Int. Cl. H04L 9/30; G06F 19/00

(52) U.S. Cl. CPC H04L 9/30; G06F 19/322

(57) ABSTRACT

System and methods are provided for securely recording private data, including but not limited to medical health data. The system and methods include a first input adapted to receive unencrypted private data and a second input adapted to receive a public key. An encryption unit is adapted to receive the private data from the first input and the public key from the second input and to provide an output of encrypted private data. A storage memory receives the encrypted data, the memory having an input adapted to receive the output of encrypted private data from the encryption unit. Overall, the system is characterized in that the private data is stored in the storage memory solely in the form of encrypted private data provided as output from the encryption unit and not as unencrypted private data.

### PRIORITY CLAIM

This application claims priority to and the benefit of U.S. Provisional Application No. 62/102,858, filed Jan. 13, 2015 (our reference 701,376-004), the content of which is hereby expressly incorporated herein by reference in its entirety as if fully set forth herein.

### FIELD OF THE INVENTION

Systems and methods are provided for securely storing and transmitting confidential medical information on vulnerable devices and networks. More particularly, systems and methods provide for the encryption of data for storage on generally unsecure devices.

### BACKGROUND OF THE INVENTION

The information age provides many opportunities to innovate upon the way medical records are handled. However, there are additional challenges associated with handling sensitive medical records on digital devices. Unlike physical records, digital records can be unintentionally copied or retained, and as such should be handled far more carefully.

The Health Insurance Portability and Accountability Act of 1996 (“HIPAA”) addresses these issues by providing specific requirements for the proper treatment of Protected Health Information (“PHI”) and electronic records of PHI (“ePHI”). Specifically, HIPAA requires that ePHI stored on a computer system and/or crossing an open computer network must be protected with data encryption technology.

Various sources develop telemedicine software designed to operate in a patient's home. Because of the nature of the home environment, this imposes a few constraints. First, computers and computer networks in the home are not secured to the same degree as in medical institutions, if at all. Second, computers and computer networks in the home are of uncertain reliability and can fail at unexpected times. Third, home users are rarely trained in computer security and should not be expected to perform any kind of manual setup to properly secure their confidential medical records.

These constraints give rise to a unique set of requirements for the proper handling of ePHI in such an environment. First, because of the lack of secure home networks, ePHI must not be transmitted over a home network until it is encrypted. Second, because of the risk of computer failure, ePHI must be stored locally until it is offloaded, no longer needed by the in-home telemedicine software, and/or successfully transferred to a secure computer. Third, because of the lack of secure home networks, the home computer cannot be expected to handle data saved to its local storage in a secure manner. Finally, because of lack of training in computer security, any security credentials necessary for such encryption to operate property must be handled automatically, such that it requires minimal-to-no intervention from the user to function. In addition, the device generating the ePHI may be a system shared by multiple patients, such as in an inpatient facility or briefly leased to a number of patients.

This also creates a unique problem: because of lack of secure home networks, any such credentials must themselves be handled securely, but because of the risk of computer failure, the credentials must also be saved locally. These conflicting requirements have been solved with the instant inventions.

### SUMMARY OF THE INVENTION

System and methods are provided for securely recording private data, including but not limited to medical health data. The system and methods include a first input adapted to receive unencrypted private data and a second input adapted to receive a public key. An encryption unit is adapted to receive the private data from the first input and the public key from the second input and to provide an output of encrypted private data. A storage memory receives the encrypted data, the memory having an input adapted to receive the output of encrypted private data from the encryption unit. Overall, the system is characterized in that the private data is stored in the storage memory solely or exclusively in the form of encrypted private data provided as output from the encryption unit and not as unencrypted private data. In other words, ePHI must be encrypted prior to its storage on the local storage or memory.

For each ePHI record, this issue is solved in one of two distinct ways depending on the needs of the ePHI record. For records which are generated by an external system and electronically delivered to the in-home telemedicine software, a confidential symmetric-key encryption scheme may be used. For records which are generated by the in-home telemedicine software, which must be secured and retained until they can be successfully transferred to a secure computer, cryptographic techniques allow for encryption of ePHI, where such encryption cannot be reversed by the same computer system.

In one form of ePHI, in-home telemedicine software creates real-time video recordings of patients as they perform physical therapy exercises. For real-time medical recordings, such as video, voice, or time-series biometric data, it is often desirable to preserve the information is non-volatile digital storage on-the-fly so that the amount of information lost in the event of an unexpected power or system failure is kept to a minimum. This data may also be quite large and require an extended period of time to transfer to the clinician or medical record system.

To this end, the disclosed computer file format allows for efficient, secure, real-time, and fault-tolerant storage of sensitive medical records, as well as systems and techniques for the proper handling of such computer files.

In yet another aspect, the system and methods may include a compression unit to provide a data compression step, preferably prior to the encryption step in the encryption unit.

In yet other aspects, the systems and methods may be used in combination with sensors for detecting patient or user state or activity, such as a wearable sensor or an implantable sensor. The system may be used with an image sensor, such as a two dimensional or three dimensional camera. Various biometric or bioelectric sensors, such as Electroencephalogram (EEG), Electrocardiogram (ECG/EKG), Electromyogram (EMG), Mechanomyogram (MMG), Electrooculography (EOG), Galvanic skin response (GSR) or Magnetoencephalogram (MEG) sensors, may be used in combination with the systems and methods.

Accordingly, it is an object of these inventions to provide for secure encrypted storage of ePHI on an otherwise unsecure system and to permit the secure transmission of the encrypted ePHI over otherwise unsecure networks.

### BRIEF DESCRIPTION OF THE DRAWING

FIG. 1 is an overview of the file structure used with the invention.

FIG. 2 is a flow chart of data used in the encryption system.

FIG. 3 is a flow chart depiction of the lifecycle of the encryption and use of a representative exercise video.

### DETAILED DESCRIPTION OF THE INVENTION

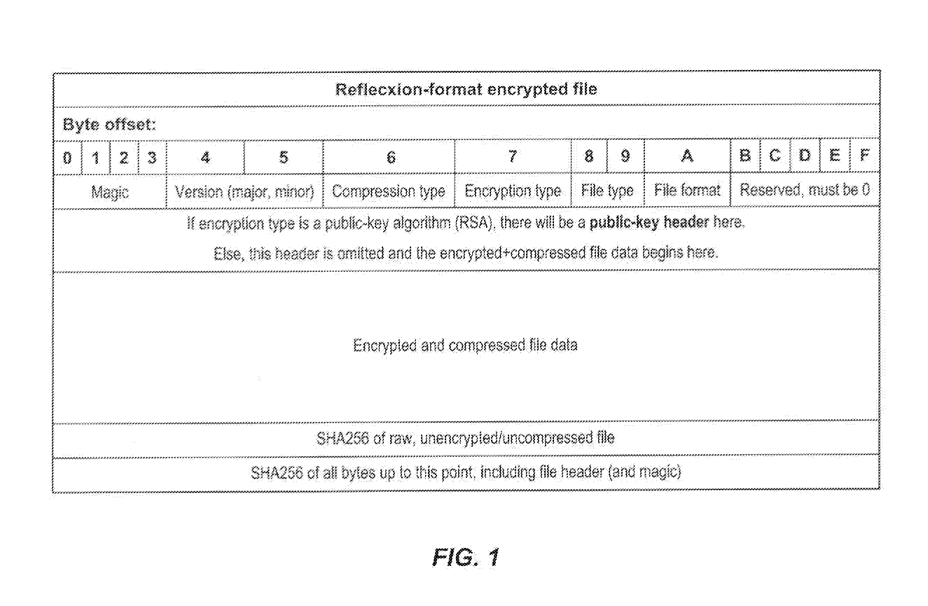

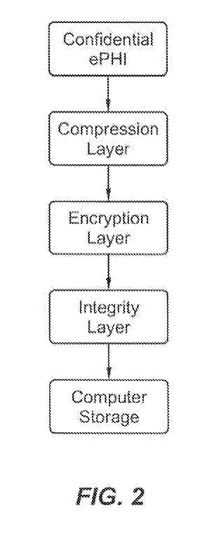

For data to be properly stored into a finalized format file (see FIG. 1), it must be run through a multi-stage process consisting of multiple layers (see FIG. 2), in which it is prepared for optimal size and security for storage on, and transit across, vulnerable computer systems. This process is engineered for streaming operation, allowing the storage of arbitrary-length data files when the total size is not known ahead of time and/or when the data to be stored is only available strictly sequentially.

The streaming and strictly-sequential operation of the encryption process not only provides for minimal latency and maximal throughput when saving encrypted video recordings directly to nonvolatile storage, but also allows the output from a video-format encoder to be routed directly into the encryption pipeline, without requiring that any volatile (outside of the data capture device) or nonvolatile memory store unencrypted video, even temporarily, thus allowing the user to meet its video-recording needs with minimal impact on system performance and reliability. Optional information may be provided, such as in a header field, including information on the magic number (sometimes referred to as a file signature), version number, compression type, encryption type, file type and file formal. If the encryption type is a public key algorithm, such as RSA, the format may include a public-key header. If not, that header may be eliminated. Following the headers, encrypted, and if a compression step is used, the compressed data, is provided. A hash, such as SHA256, of the raw, unencrypted and uncompressed data follows. Finally, a hash, such as SHA256, of all bytes up to this point (preferably including the file header and magic number in the file) may be provided.

With particular reference to FIG. 2, the layers employed in the multi-layered encryption process are as follows. First, the compression layer optionally allows for compression of the underlying data using industry-standard compression algorithms, such as the DEFLATE algorithm. Second, the encryption layer allows for protecting the stream of data from the compression layer using one of many industry-standard symmetric-key encryption algorithms, such as the Advanced Encryption Standard (AES), for when data must be recoverable by the same system that stored it, or one of many industry-standard public-key encryption algorithms, such as RSA, for when data must not be recoverable by the same system that stored it. Third, the integrity layer affixes metadata (see FIG. 1) to the resulting file prior to storage so that the same security settings that were used to store the file can be used to read the file later. This metadata also allows for the detection of data corruption by affixing two cryptographic hashes calculated using the SHA-256 algorithm to the end of the file.

This formal is designed to be extensible and flexible in order to store many different types of confidential data while ensuring the continued availability, integrity, and security of all records involved. However, the file formal alone is not sufficient to ensure proper and timely delivery of confidential records to their destination.

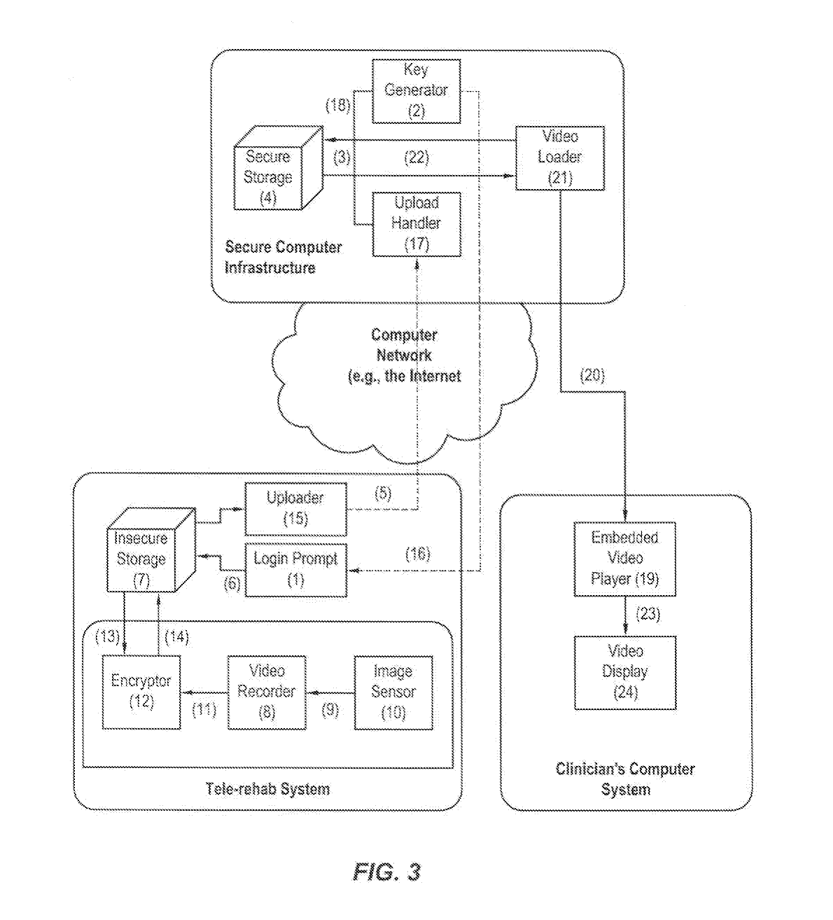

FIG. 3 depicts the lifecycle of an exemplary set of ePHI, such as a patient exercise video file. In this case, the record is a video of a patient that is recorded at one moment and replayed at a later date. At all times, the video is to be kept secure and guarded with integrity-checking message hashes. As shown, the secure image device is an optional segmentation of these functions into a separate device, but may also be integrated within the system.

In this example a patient begins by logging in (1) to the system, which requests a key pair from the key generator (2). The private key is stored (3) in the computer systems secure storage (4). The public key is sent (5) to the patient's computer for storage, to be kept until it is needed. The public key is only capable of encrypting, and not decrypting, data and is therefore not considered sensitive information, thus it can be stored (6) on the patient's non-secured local hard drive (7).

When the patient begins recording their video, a video recorder (8) (sometimes called a “video encoder”) begins pulling a visual stream (9) from an image sensor (10) and encodes the stream into a format suitable for transmission and storage, which is then sent (11) directly to the encryptor (12) which encrypts the stream in real-time by using (13) the public key and stores (14) the encrypted stream in the local storage (7). The video recorder, image sensor, and encryptor may be a single unit separate from the computer system.

When the patient is finished recording the video and has an Internet connection, the uploader (15) transmits (16) the file to the upload handler (17) on the system. Because the file is already secured by the encryptor (12), no special security considerations are necessary to ensure the confidentiality of the data crossing the Internet during the upload. Once received, the upload handler (17) checks the integrity of the file, and can automatically request a re-upload if file corruption is detected, or store (18) the file into the secure storage (4) if the file is determined to be intact.

When the clinician wishes to view the video, their video player (19) can establish an SSL-secured connection (20) to the video loader (21) which retrieves (22) the encrypted video and private key from the secure storage (4), decrypts the video using the private key, and streams it down to the clinician's video player (19) via the SSL-secured connection (20) to be shown (23) on the clinician's video display (24).

In this system, we see that at no point is ePHI (or any sensitive credentials necessary to access ePHI) handled by insecure storage or network connections. Sensitive information is sent directly through the encryption system before being placed in the open, and at no point can an eavesdropper or unauthorized user gain access to the confidential information as it crosses an insecure network and/or is stored on an insecure data storage device.

Note that the video recorder (8), image sensor (10) and the encryptor or encryption unit (12) may be part of a separable secure image device that is used as a peripheral to a computer or mobile computing device.

Although the foregoing invention has been described in some detail by way of illustration and example for purposes of clarity and understanding, it may be readily apparent to those of ordinary skill in the art in light of the teachings of this invention that certain changes and modifications may be made thereto without departing from the spirit or scope of the claims.

All publications and patents cited in this specification are herein incorporated by reference as if each individual publication or patent were specifically and individually indicated to be incorporated by reference in their entirety.

1. A system for securely recording private data, comprising:
a first input adapted to receive unencrypted private data,
a second input adapted to receive a public key,
an encryption unit adapted to receive the private data from the first input and the public key from the second input and to provide an output of encrypted private data,
storage memory having an input adapted to receive the output of encrypted private data from the encryption unit,
the system characterized in that the private data is stored in the storage memory solely in the form of encrypted private data provided as output front the encryption unit and not as unencrypted private data.

2. The system for securely recording private data of claim 1 further including a data compression unit between the first input and the encryption unit.

3. The system for securely recording private data of claim 1 wherein the first input is a video input.

4. The system for securely recording private data of claim 3 further including a camera.

5. The system for securely recording private data of claim 4 wherein the camera is a video camera.

6. The system for securely recording private data of claim 5 wherein the camera is a three dimensional (3D) camera.

7. The system for securely recording private data of claim 1 wherein the first input is a bioelectric signal input.

8. The system for securely recording private data of claim 1 further including a wearable sensor, wherein wearable sensor provides unencrypted private data to the first input.

9. The system for securely recording private data of claim 1 further including an implantable sensor, wherein the implantable sensor provides unencrypted private data to the first input.

10. The system for securely recording private data of claim 1 further including a transmission unit for transmitting the encrypted private data to a remote unit.

11. The system for securely recording private data of claim 10 wherein the remote unit is the unit that provided the public key.

12. The system for securely recording private data of claim 1 further including an integrity check unit.

13. The system for securely recording private data of claim 1 further including an completeness check unit.

14. A system for securely recording private data, comprising:
a first transmission unit adapted to store and transmit a public key,
a first input adapted to receive unencrypted private data,
a second input adapted to receive the public key,
an encryption unit adapted to receive the private data from the first input and the public key from the second input and to provide an output of encrypted private data,
storage memory having an input adapted to receive the output of encrypted private data from the encryption unit,
the system characterized in that the private data is stored in the storage memory solely in the form of encrypted private data provided as output from the encryption unit and not as unencrypted private data.

15. The system for securely recording private data of claim 14 further including a data compression unit between the first input and the encryption unit.

16. The system for securely recording private data of claim 14 wherein the first input is a video input.

17. The system for securely recording private data of claim 14 further including a wearable sensor, wherein wearable sensor provides unencrypted private data to the first input.

18. The system for securely recording private data of claim 14 further including an implantable sensor, wherein the implantable sensor provides unencrypted private data to the first input.

19. The system for securely recording private data of claim 14 further including a transmission unit for transmitting the encrypted private data to a remote unit.

20. The system for securely recording private data of claim 14 further including an integrity check unit.
